(19) United States
(12) Patent Application Publication
(10) Pub. No.: US 2004/0117494 A1
(43) Pub. Date: Jun. 17, 2004

(54) Method and system for dynamically reconfiguring pervasive device communication channels

(76) Inventors: Larry J. Mitchell, Toronto (CA); Sujatha L. Bayyapureddy, Sterling Heights, MI (US)

Correspondence Address: HOGAN & HARTSON LLP, ONE TABOR CENTER, SUITE 1500, 1200 SEVENTEEN ST., DENVER, CO, 80202, US

(21) Appl. No.: 10/320,190

(22) Filed: Dec. 16, 2002

(51) Int. Cl. G06F 15/16

(52) U.S. Cl. 709/230; 709/220

(57) ABSTRACT

A method for dynamically reconfiguring and for provisioning a communications channel for a service running on a client. The method includes providing network protocol elements and channel filters configured to define or understand an upper level or application communications protocol. Then, based on particular service communications parameters, selecting one or more of the filters and combining it with a protocol element to form a communications channel for use by the service. The channel filters are service bundles within a client architecture, such as an Open Services Gateway Initiative (OSGi) compliant architecture. The method includes receiving additional channel filters and reconfiguring built communication channels to include updated or new channel filters, such as dynamically when the service is next called or instantiated.

### BACKGROUND OF THE INVENTION

1. Field of the Invention

The present invention relates, in general, to pervasive computing systems and communication methods and protocols utilized by these pervasive computing systems, and, more particularly, to software, systems, and methods for facilitating the dynamic initial configuration and later reconfiguration of communication channels for inputting data to pervasive devices, such as wireless devices including in-vehicle networks, residential computer networks, telephony devices, and the like and for controlling communications between the pervasive devices of a particular network. Such a system includes a communication manager, which may be provided with a services gateway, for allowing applications to periodically update or change their communication channels, e.g., communication protocols and the like, by updating one or more channel filters utilized by the application and controlled by the communications manager.

2. Relevant Background

In the computer and information technology industry, the demand is rapidly growing for pervasive computing that allows people ubiquitous or ongoing access to information and services through the use of portable computers and wired and wireless networking. In the automobile industry alone, telematics is projected to become a $20-billion industry within the next decade. Telematics is a term used to describe the hardware and software technologies used to provide in-vehicle (or on-client for non-mobile implementations) multimedia, and infotainment.

In the automobile industry, telematics technologies include a number of functional areas including vehicle integration, remote vehicle services, and near vehicle interaction. Vehicle integration technologies or services provide enhanced control of vehicle operations including heating and ventilation, entertainment systems, ongoing diagnostics, and the like. Remote vehicle services include wireless Internet access and the providing of Internet-based services commonly available for desktop computers such as e-mail messaging, calendaring, commerce, and streaming media via cell-based network protocols (e.g., CDMA, GSM, GPRS, WCDMA, UTMS, and the like). Near vehicle interaction includes services such as smart highways, tolls, gas pump-based services, and vehicle-to-vehicle safety systems (e.g., collision detection and avoidance). An example of a non-mobile implementation would be a residential or home network in which pervasive computing devices may provide services such as communication, information, entertainment, safety and security monitoring, energy management and metering, appliance diagnostics and servicing, and telemedicine and healthcare monitoring. The use and availability of telematics in vehicles (or other mobile clients) such as automobiles, boats, airplanes, and mobile or wireless computers and in homes and businesses (or non-mobile clients) is expected to continue to grow rapidly in the future but such growth will be hindered as long as customers perceive telematics as an expensive and impractical toy.

For pervasive computing to be more fully adopted, an end-to-end communications framework has to be developed that supports the various long life cycles of the products (such as cars and homes) in which embedded and pervasive computing devices are installed or provided and that also supports the rapidly changing software, hardware, and communications technologies. For example, an in-vehicle computing system is an integral part of the vehicle and is linked to its systems. The in-vehicle system typically includes numerous applications that operate to provide the services or functionality of the system and these applications may use a number of standardized protocols along with proprietary protocols to address and control the communication needs of the vehicle as it leaves the factory. Unfortunately, this arrangement generally requires that the data being exchange remain relatively static throughout the vehicle life as updating embedded systems and devices is often difficult and expensive.

A further complication is created by the interaction of the pervasive system with outside services. Many pervasive systems do not operate in a vacuum but instead are configured to communicate with outside service providers such as over the Internet or other digital communications network via a wired or wireless connection. Again referring the automotive industry, communication with a service provider for delivery of applications and services into the vehicle for diagnostic applications, for wireless-based applications, for telematic services, and the like. The nature of these and other applications being rapidly developed is that they require that data is delivered into and retrieved from the vehicle system. The sources of such data could include nearly any entity that has relevant information for the application or service such as an off-board server (such as a service provider telematics server), a wireless phone, a PDA, and many more.

Handling all of these types of incoming and outgoing data is that each of these outside sources may require different information content and utilize different communication protocols. Further, each time an application is added to the pervasive system it needs to be implemented to comply with existing communication protocols or be adaptable to the communication systems in place or that may later be added. This has proven to be a difficult problem compounded with the long design cycles of many products. For example, a vehicle may require several years to design with protocols becoming obsolete or non-standard by the time the vehicle and its embedded devices are actually produced. Further, a vehicle is typically in service for years and communications technologies including protocols change several times during the vehicles useful life.

Yet another complication is added by the inclusion of numerous different applications within a pervasive system. Each application may have different parameters of communication and may vary with the hardware of the vehicle or other structure housing the pervasive system For example, the data exchanged between the off-board system and the on-board or in-vehicle system may be encrypted for security reasons or be compressed based on various algorithms. The security and compression algorithms may vary from application to application and may change many times over the service life of the on-board or in-vehicle system. Other data transfigurations, such as the recently developing need for eXtensible Markup Language (XML) translations, may be essential or may later become required to support wired and/or wireless communications among the different software systems within a single device or network or with off-board devices such as service provider servers. Currently, there is no solution that provides a flexible and extensible communication mechanism that is able to communicate with the off-board or outside world while effectively controlling internal communications among the various devices and running applications. Existing communication mechanisms have tended to be specific to particular hardware and software existing in a pervasive system or required explicit communication filters or rules on communication parameters and, in either case, have not been designed to be readily modified

Hence, there remains a need for an improved method and system for use in mobile clients or mobile computing platforms, such as automobiles, boats, airplanes, and mobile computers and computing devices, and in non-mobile computing platforms, such as homes and businesses, to manage communications within a pervasive computing environment. Preferably, such a method and system would create a communication framework in which applications that directly or indirectly use the data delivered to or from the computing platform that is uncoupled from the particular communications management technique to allow reduce the cost and complexity of adding and modifying applications and of updating the communications management technique.

### SUMMARY OF THE INVENTION

The present invention addresses the above problems by providing a method (and corresponding software and hardware components) for use in a client such as a wireless mobile client for providing a dynamically reconfigurable communications channel for a service running on the client. The method includes providing one or more protocol elements that are adapted to define and/or understand a lower level or network communications protocol and also providing a set of channel filters that are each configured to define and/or understand an upper level or application communications protocol. The method further includes receiving a communications request for a service on the client and then, based on the particular service communication requirements or parameters, selecting one or more of the filters from the provided set. The elected filter(s) is then combined with one of the protocol elements to form a communications channel for use by the service as a data pathway. The communications channel is made available to the service, and this is achieved in one embodiment by providing the channel filters as service bundles within the client architecture (such as, but not limited to, Open Services Gateway Initiative (OSGi) service bundles on an OSGi-compliant computing architecture).

According to one aspect of the invention, a communications channel includes an in channel comprising a network protocol element and one or more channel filters for understanding data into the service and an out channel comprising a network protocol element and one or more channel filters for formatting data transferred from the service. The in channel and the out channel can be formed differently with different network protocol elements and/or different channel filters. The channel filters typically are configured to understand or handle application-level communications protocols such as those involved in encryption, compression, and data transfiguration including XML-based or related protocols. Preferably, the method includes receiving additional channel filters and then reconfiguring already built communication channels to include updated or new channel filters such as when the service is next called or instantiated.

### BRIEF DESCRIPTION OF THE DRAWINGS

FIG. 1 illustrates in block diagram form an extensible communications system according to the present invention that is adapted for provisioning communication filters and protocol elements to clients with pervasive computing systems for use in dynamically building communication channels for application or services;

FIG. 2 illustrates in more detail portions of a pervasive computing system such as may be installed on one of the clients of the system of FIG. 1 showing in more detail the components used to create communications channels for service components;

FIG. 3 illustrates an exemplary architecture for implementing the communications manager and filter and protocol services or elements of the invention;

FIG. 4 is a flow chart illustrating exemplary functions performed by an extensible communications system, such as the system of FIG. 1, and particularly of the communications manager in controlling communications within a pervasive computing system; and

FIG. 5 is a simplified class diagram illustrating one architecture and useful classes for implementing a communications manager system of the invention.

### DETAILED DESCRIPTION OF THE PREFERRED EMBODIMENTS

The present invention is directed to methods and systems for providing a dynamically reconfigurable or “generic” communication channel that allows data to be transferred to and from as well as within a pervasive computing system or network (such as in an in-vehicle computing system, a residential or business network, within a mobile device such as a PDA, cell phone, and the like) that may utilized wired or wireless communication technologies. The communication channel is provided generally with a communications manager the is configured to build, such as with a channel factory, communication channels into and out of applications or service components within each pervasive computing network or within each pervasive device. The communications manager has access to a set of available protocol elements defining a network protocol for each fabricated channel and a set of available channel filters that define one or more communication parameters. The in channels and out channels for each service component are built by combining a single protocol element with one or more channel filters.

The channels can be fabricated to support streaming, synchronous, and asynchronous data transfer using any of the available protocol elements and the application level protocols or parameters defined by the filters. In this manner, the communications manager of the present invention abstracts or hides the fabrication of the channel from the service components that allows ready updates to either the service components or the components forming the channels. For example, the communications manager allows the applications or service components to dynamically add or remove security, compression, encryption, and other communication parameters by adding, removing, or updating (such as by altering a filtering algorithm) channel filters. Preferably, the communications manager operates to create the channels independently of the underlying communication contents and the internal structures of the filters and protocol elements. The service components or applications can be dynamically extended to use newly added service components that utilize the latest protocols and filters without any obstruction to the existing service components by dynamically reconfiguring the existing service component's channel(s).

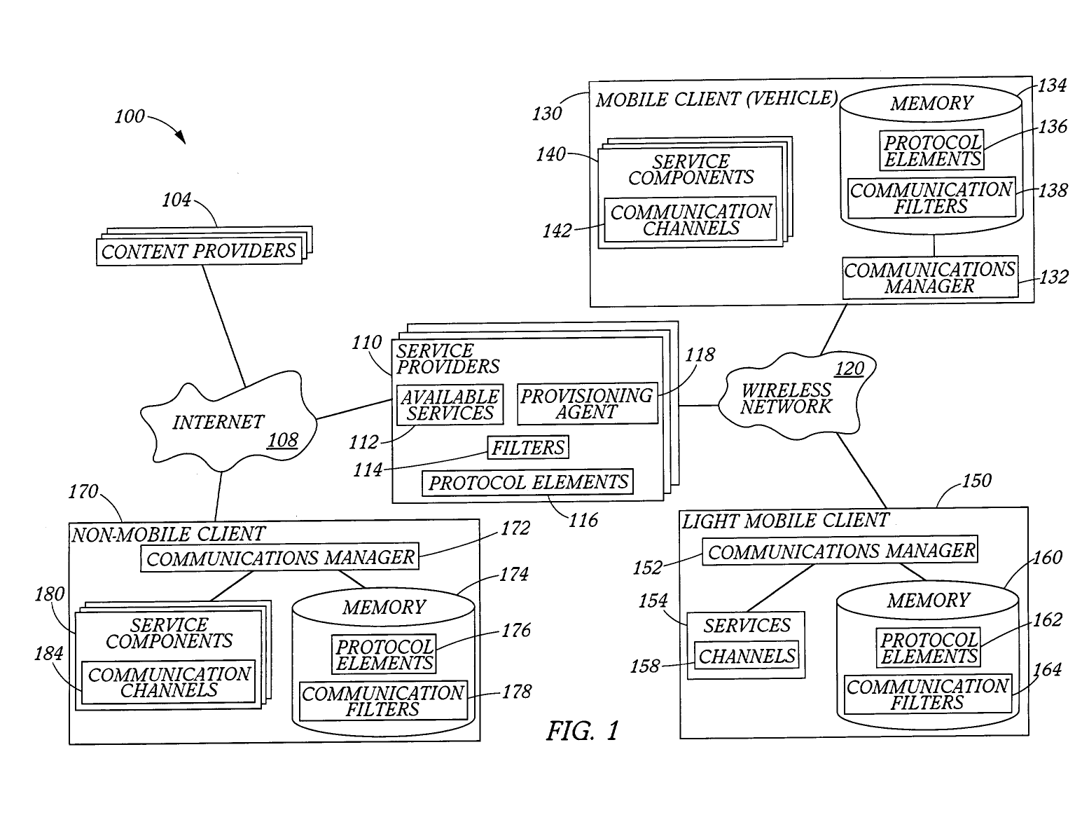

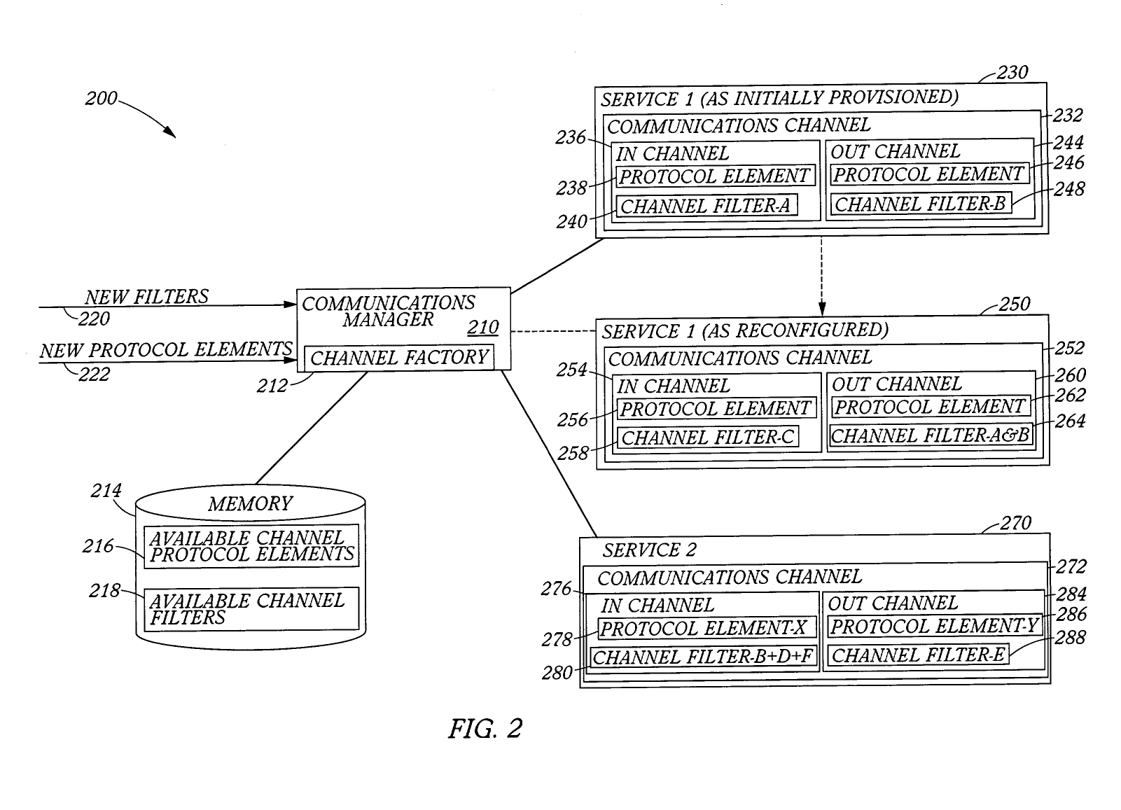

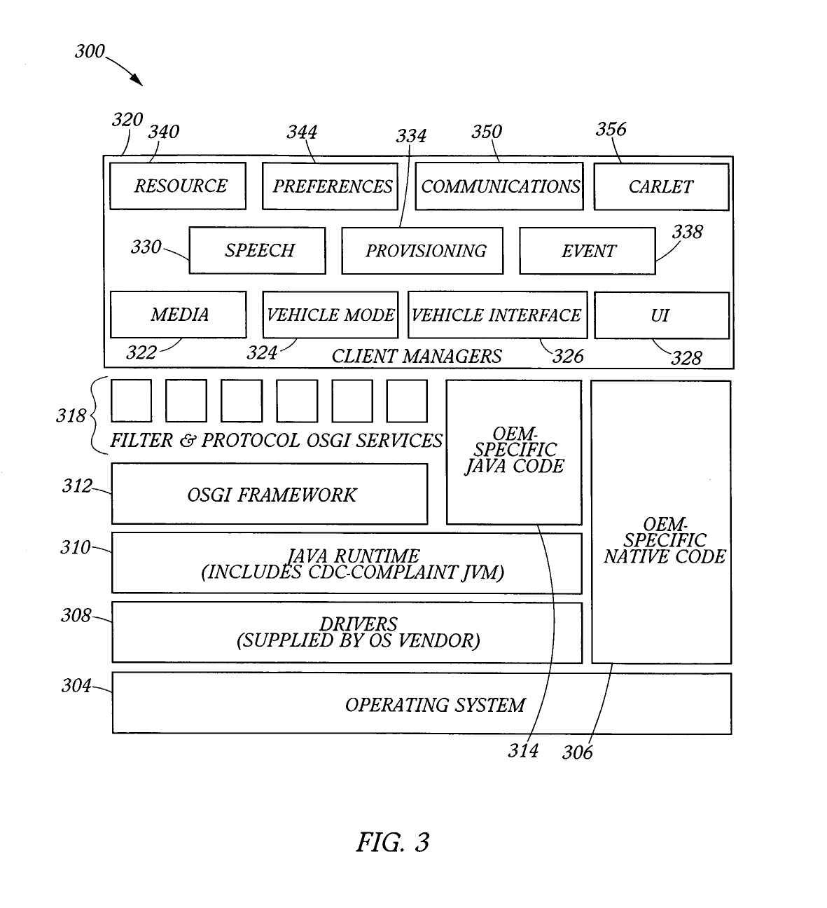

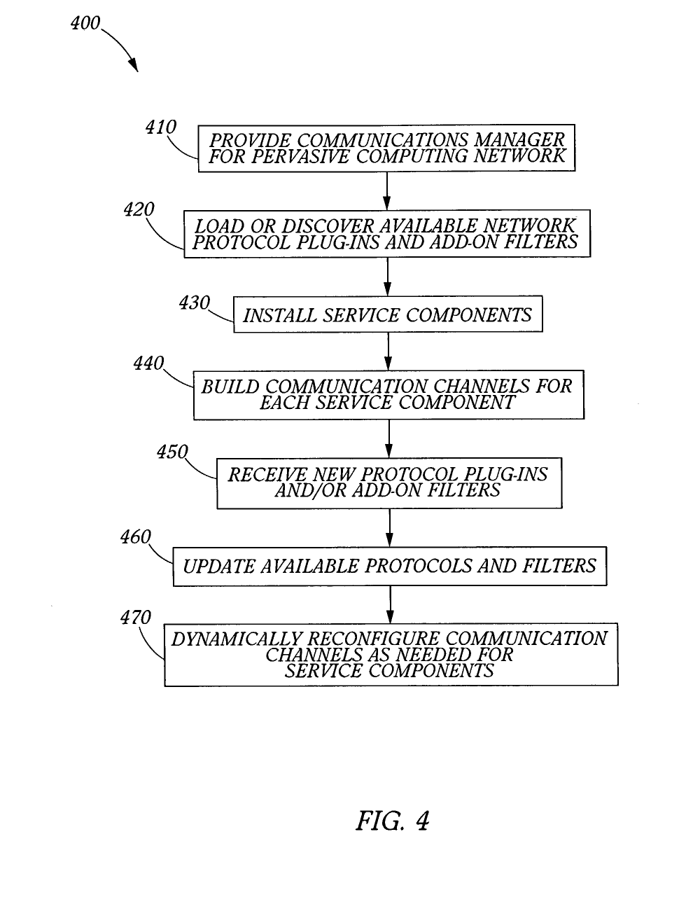

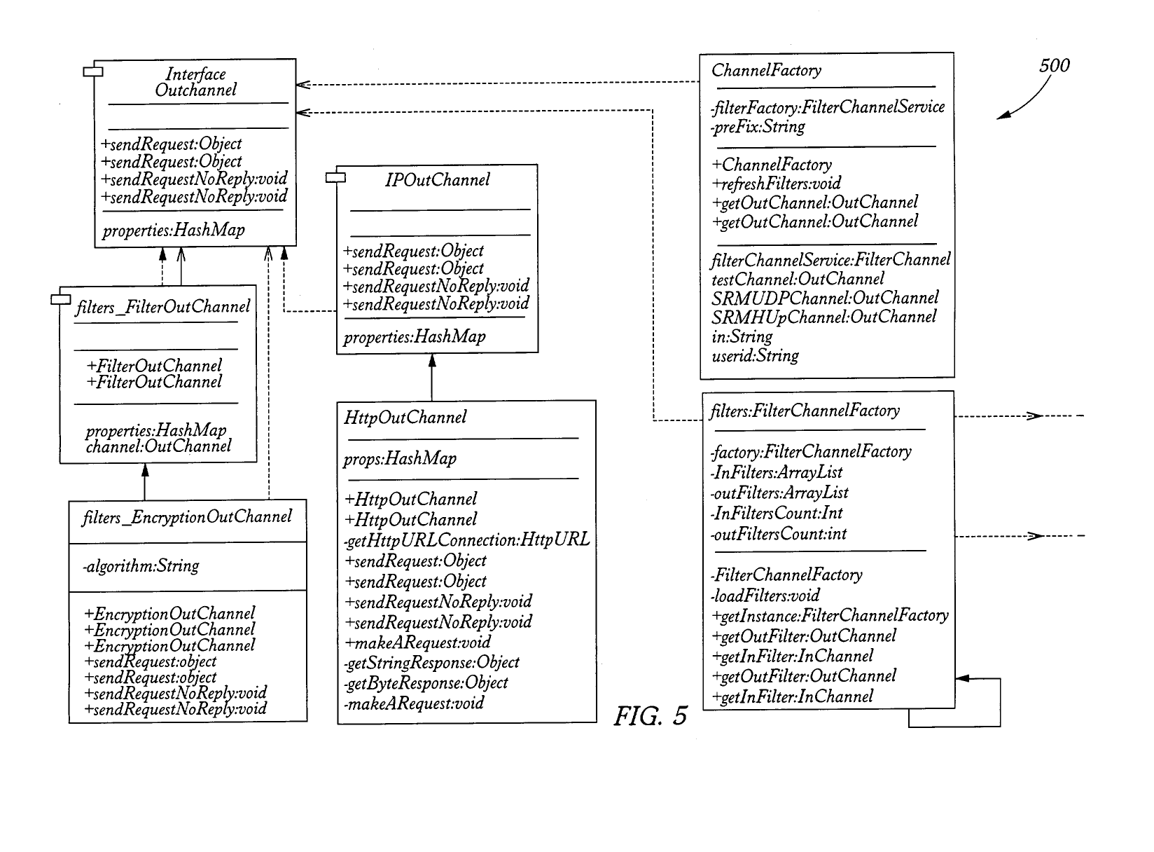

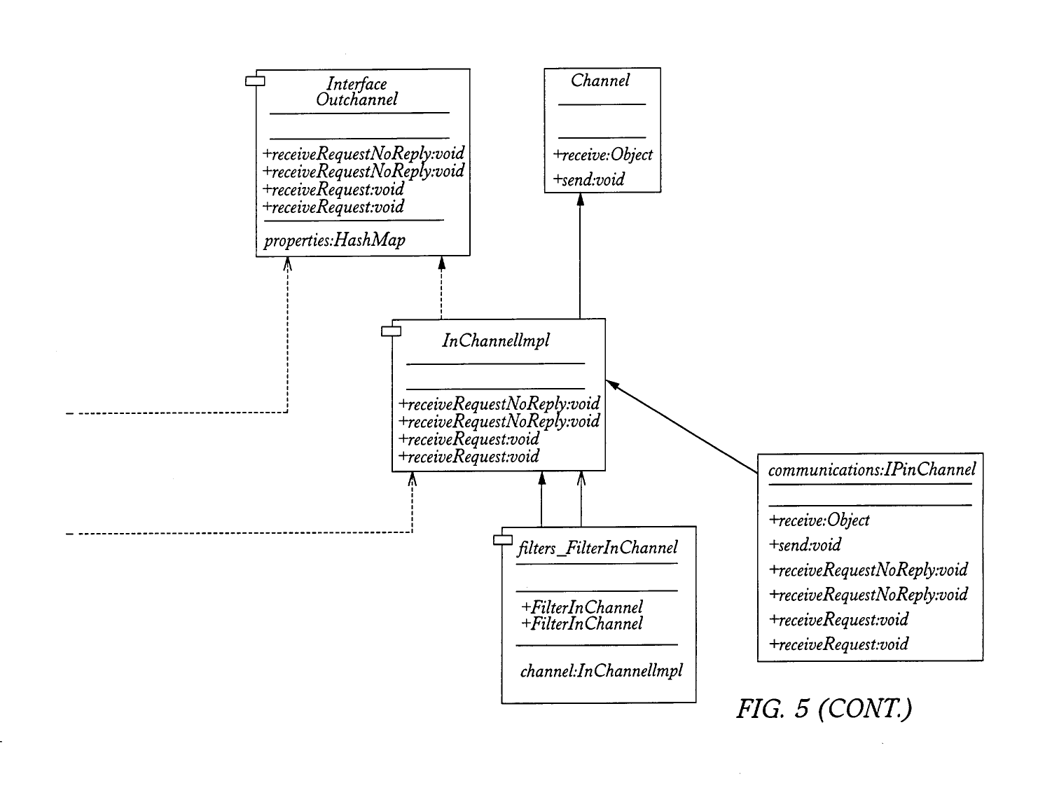

The following description begins with a general description of an extensible communications system 100 with reference to FIG. 1 that illustrates how the systems and methods of the present invention support building communications channels for service components of pervasive networks or devices and, in some embodiments, support provisioning of filters and/or protocol elements for updating pervasive networks and/or for dynamically reconfiguring existing communication channels. An exemplary communications manager is further explained with reference to FIG. 2 with the operation of the manager 210 explained within a simplified pervasive computing system 200. FIG. 3 is used to describe a Java™ implementation of a communications architecture 300 that can be used to successfully practice the concepts of the invention. Operation of a extensible communications system, such as system 100, is then described more fully with reference to the operating process 400 shown in FIG. 4. Next, FIG. 5 provides one simplified class diagram that provides some of the more important classes that can be used in Java™ implementations of the invention.

In the following discussion, computer and network devices, such as the software and hardware devices within the mobile client 130, the light mobile client 150, the non-mobile client 170, the on-board communications system 200, and the service providers 110, are described in relation to their function rather than as being limited to particular electronic devices and computer architectures. To practice the invention, the computer and network devices may be any devices useful for providing the described functions, including well-known data processing and communication devices and systems such as portions of in-vehicle computer systems, personal digital assistants, personal, laptop, and notebook computers and mobile computing devices with processing, memory, and input/output components, and server devices configured to maintain and then transmit digital data over a communications network. Similarly, the wired and wireless client devices may be any electronic or computing device for transmitting digital data over a wired or wireless network and are typically installed or resident within mobile vehicles such as automobiles, airplanes, ships, mobile computers and computing devices, and the like or in stationary structures such as residential structures or buildings utilized by businesses. Data, including client requests, service provider or carrier and content provider requests and responses, and transmissions to and from the clients 130, 150, 170 and among other components of the system 100 typically is communicated in digital format following standard communication and transfer protocols, such as TCP/IP, HTTP, HTTPS, FTP, IMAP and the like, or IP or non-IP wireless communication protocols such as TCP/IP, TL/PDC-P, WSP, Bluetooth, 802.11b, and the like, but this is not intended as a limitation of the invention. Additionally, the invention is directed toward provisioning of communication filter and protocol elements and the dynamic creation of communication channels for applications on clients 130, 150, 170, but is not limited to a specific native language within the client devices (although Java™ language implementations are provided for the sake of simplicity and to provide at least on specific example), a particular function of an application, or a specific client configuration.

FIG. 1 illustrates an extensible communications system 100 according to the present invention adapted for dynamic reconfiguration of communication channels within client devices and for provisioning of components for making new channels (e.g., new or updated filters and/or network protocol elements). As shown, the system 100 includes content providers 104 linked to the Internet 108 (or other digital communication network such as a LAN or WAN) and also linked to the Internet 108 are service providers 110. The service providers 110 function generally to provide applications and to collect and deliver data needed for such applications (such as from content providers 104). The service providers 110 may be implemented as telematic service providers (TSPs) or telematics servers that are configured generally to support communication between the clients 130, 150, 170 and server-based application components, to manage deployment of on-board (e.g., in-vehicle) software, to allow remote management of client devices 130, 150, 170, and to provide storage for and access to users' preferences data.

More particularly, the service provider 110 stores (or has access to) available services or software applications 112, available communication filters 114, and available protocol elements 116. As will become clear, communication channels built within the clients 130, 150, 170 and used by client applications or service components 140, 154, 180 are formed generally by the combination of a single protocol element, such as element 116, that defines network protocols and one or more communication filters, such as a filter(s) 114 that define communication parameters (such as what security measures are to be taken and how to apply such measures). A provisioning agent 118 is provided on the service provider 110 to control which services 112, filters 114, and protocol elements 116 are made available which clients 130, 150, and 170. The provisioning agent 118 responds to discovery requests from the clients 130, 150, 170 and when appropriate transfers or provisions the services 112, filters 114, and protocol elements 116 to the clients 130, 150, 170. The filters 114 and protocol elements 116 may be provided by the content providers 104 or another third-party and typically are registered within the service provider 110 (such as in a filter and protocol element registry) and then announced or pushed (or otherwise made available) to the clients 130, 150, 170. Once the filter 114 and/or network protocol element 116 has been deployed to the client 130, 150, 170 the client 130, 150, 170 may begin to use the filters 114 and elements 116 in forming or reconfiguring service component communication channels, as explained below in detail. The service provider 110 may further, such as with the provisioning agent 118, maintain a database (not shown) with information about which filters 114 and which protocol elements 116 have been deployed to which clients 130, 150, 170.

The system 100 includes one or more mobile clients 130 such as vehicles with an in-vehicle pervasive computing system and one or more light mobile clients 150 such as PDAs, cellular phones, and the like with less computing and memory capacity. Both mobile clients 130, 150 are wireless clients linked to the service provider(s) 110 via a wireless network 120, which provides voice and data connectivity between on-board or in-vehicle computing systems or telematics units and the back-end infrastructure of the system 100. The clients 130, 150 provide the in-vehicle or in-device infrastructure and execution or computing environment and may include a variety of connected vehicle hardware such as sensors, actuators, displays, GPS units, and other components (not shown) but each of which is typically provided functionality by a set of services or service components 140, 154. A component is generally a self-contained software module that is or can be loaded into an existing infrastructure, and a service or service component 140, 154 can be thought of as a component that has a relatively well-defined function set that can be used by other software elements and other service components 140, 154.

A communications manager 132, 152 is provided in the clients 130, 150 to define and manage the communications with the client 130, 150 and the service provider 110 and, importantly, to control communications within the clients 130, 150 and among the service components 140, 154. To this end, the communications managers 132, 152 are adapted to build communication channels 142, 158 that are then used by the service components 140, 158 in receiving or importing data and in transferring data to other service components 140, 158 or to the service provider 110. Each channel 142, 158 is linked to the specific service component 140, 154 to meet the in-and-out data requirements for that particular service component 140, 154 and defines a pathway through which information is transmitted between the service component 140, 154 and a sending or receiving component or entity. The communications manager 132 152 forms the channels 142, 158 from protocol elements 136, 162 and communication filters 138, 164 stored in memory 134, 160 on the device 130, 150 (or retrieved as needed from the service provider 110 to reduce memory requirements of the clients 130, 150). Each channel 142, 158 includes a single protocol element 136, 162 that defines or understands low-level network protocol stacks such as UDP, HTTP, Bluetooth, and the like and one or more of the filters 138, 164 which define or understand higher level protocols such as application level protocols including encryption, XML-oriented protocols (e.g., SOAP and the like), compression, and other application-level protocols. The specifics of how channels, such as channels 142, 158, are formed is discussed in further detail with reference to FIGS. 2 and 4.

Preferably, the communications manager 132 and components 140, 154 are built up on a standardized service framework to facilitate composing the service components 140, 154 from a minimal code set with no or little duplication. For example, but not as a limitation, the framework or architecture for the client 130, 150 computing system may be an OSGi (Open Services Gateway Initiative) component framework. hi this example, Java™ 2 Platform, Micro Edition (J2ME) is utilized and the clients 130, 150 can be configured using connected limited device configuration (CLDC) or connected device configuration (CDC). Typically, the decision point for using CLDC or CDC is the capability, memory, and size of the client 130, 150 with CLDC being appropriate for light weight devices such as those using 16-bit processors with less than 2 megabytes (MB) of memory and CDC being useful when devices used 32-bit processors and memory of 2 MB or greater. Hence, the mobile client 130 may be an in-vehicle system or telematics control unit and be built on a J2ME CLDC platform standardized per OSGi. The light mobile client 150 may be a 16-bit processor with less than 2 MB memory (such as a PDA, cellular phone, or other mobile computing device) built on a J2ME CDC platform standardized per OSGi.

In addition to mobile devices, the system 100 includes one or more non-mobile client 170, such a business computing network, a residential wired network or pervasive computing system, a set-top box, and the like. The non-mobile client 170 is shown wired to the Internet 108 to receive data, applications, and channel components provisioned from service provider 110 (but, of course, a non-mobile client 170 may also be a wireless client and be connected to the service provider 110 via the wireless network 120). Like the clients 130 and 150, the non-mobile client 170 includes a communications manager 172 adapted for generating communication channels 184 for service components 180 to define communication pathways between the components 180 and between the components 180 and the service provider 110 (and content providers 104). The communications manager 172 builds the channels 184 from protocol elements 176 and communication filters 178 stored in memory 174 (and/or retrieved from service provider 110).

FIG. 2 illustrates in more depth an on-board communications system 200 such as would be included in the clients 130, 150, 170. As shown, a communications manager 210 is provided that is adapted with a channel factory 212 for building communication channels for various service components. The channel factory 212 may build the channels prior to their use by the service components or dynamically when the service component is implemented or called (as is often the case in object-oriented environments). The channel factory 212 creates the communication channels from a single one of the available channel protocol elements 216 in memory 214, which defines network-level protocols, and one or more of the available channel filters 218 in memory 214 that define application-level protocols or communication parameters. As discussed with reference to FIG. 1, the protocol elements 216 and channel filters 218 are typically provisioned from a service provider and this is shown by the receipt at the communications manager 210 of new filters 220 and new protocol elements 222 (or updates to these items). The communications manager 210 stores the received filters 220 and protocol elements 222 in memory 214 typically replacing any versions of protocol elements 216 and filters 218 that are being replaced and for which it is desirable that future-used channels do not includes these elements 216 and/or filters 218. This may occur when a network protocol is redefined or replaced or an algorithm used for encryption is periodically replaced for security purposes or for other reasons.

The system 200 is shown to include a first service component 230 that as initially provisioned or made available includes a communications channel 232. The channel 232 is fabricated by the channel factory 212 of the communications manager 210 to include an in channel 236 defining and/or understanding communications into the service 230 and an out channel 244 defining and/or understanding communications out of the service 230. The in and out channels 236, 244 may be identical or may differ as shown and any number of filters 218 may be used to create the channels 236, 244. As shown, the in channel 236 includes a protocol element 238 and a channel filter 240 while the out channel 244 includes another protocol element 244 (which may or may not differ from element 238) and a different channel filter 248. Often the filters 240, 248 for services 230 differ within the communication channel 232 to allow different parameters (such as security and compression) to differ for communications outside the system 200 and communications within the system 200 such as between two services 230.

According to an important aspect of the invention, the system 200 is adapted for dynamic reconfiguration of communication channels 232 to support the changing of communication parameters such as those defined by the available filters 218 and network protocols such as those defined by the available protocol elements 216. These dynamic reconfigurations can be accomplished without requiring the altering of the service 230 implementing the channel 232, which is a significant benefit for embedded and other pervasive computing networks. For example, it may be desirable to change a security algorithm used to encrypt data on a periodic basis such as once a month. This would be unduly burdensome if the service component 230 has to be modified every month. Instead, a new filter 220 can be delivered to the system 200 and stored in the available filters 218. Then, the communication channel 232 is updated to include the new filter along with the old filter 240 or such that the new filter replaces the existing filter 240.

The concept of dynamic reconfiguration is shown by the inclusion of a reconfigured first service 250. The reconfigured first service 250 includes an altered communication channel 252 that is fabricated by the channel factory 212 typically upon the service 250 being instantiated or implemented after new filters 220 and/or elements 222 have been stored in memory 214 as available elements 216 and filters 218. As shown, the reconfigured communications channel 252 includes an in channel 254 that includes the protocol element 256 (which may be the same or different than the element 238) and a channel filter 258 that is different than the filter 240 used in the initially provisioned service 230. The channel 252 also includes an out channel 260 that is reconfigured (or newly constructed by the factory 212) to include a protocol element 262 that may or may not be different from the element 244 and a pair of channel filters 264 that include the original filter 248 but further includes an additional filter from the available filter elements 218 to provide an additional communication parameter or function (such as to add compression onto encryption or vice versa).

The system 200 further includes a second service component 270 that includes a communications channel 272 built by the channel factory 212 of the communications manager 210. The communications channel 272 differs from the communication channel 232 of the first service 230 and as shown, includes an in channel 276 having a protocol element 278 and a channel filter 280 made up of three of the available channel filters 218 concatenated together to provide a suite of upper layer protocols. The communications channel 272 includes an out channel 284 with a protocol element 286 selected from the available protocol elements 216 but differing from the protocol element 278 of the in channel 276 and with a channel filter 288 again selected from the filters 218 to differ from the in channel filter 280. As can be appreciated, the combination of available filters to form channel filters may be quite large as well as the combination of such channel filters with lower layer protocols defined by the protocol elements. In this fashion, the communications manager 210 is able to support dynamic updating and reconfiguring of the communication channels 232, 252, 272 independently of the state or operation of the services 230, 250, 270.

Although a number of architectures may be used to implement the clients 130, 150, and 170, it may be helpful to describe on useful architecture for providing the functionality described herein. FIG. 3 illustrates one telematics client architecture 300 that is particularly useful for clients 130, 170 that have higher capacity processors and memory available. The illustrated architecture 300 is an OSGi architecture with a J2ME CDC platform but, of course, other container frameworks (such as any Java-based container framework or other object-oriented framework) or other architectures may be utilized for the architecture 300. As with other OSGi architectures, the client architecture 300 is built on an operating system 304 (such as the host operating system for the client 130, 170) upon which drivers 308 and original equipment manufacturer (OEM) specific native code 306 are provided. The client architecture 300 further includes a virtual machine 310, such as a CDC-compliant Java™ Virtual Machine (JVM), upon which are built the OSGi framework 312 and OEM-code 314 specific to the virtual machine 310.

In OSGi-based architectures such as architecture 300, components are called service bundles and the filters and protocols (such as filters 138 and protocol elements 136 of FIG. 1) are structured to have independent existence from each other. As illustrated, the filters and protocol elements are implemented as OSGi service bundles 318 in order to have the capability to independently add, remove, and manage these elements (and later build communication channels with the communications manager 350).

The architecture 300 includes a number of components (such as Java™ software components) called client managers 320 to provide a on-board or in-vehicle services. As shown, the set of managers (and/or APIs) 320 includes media 322, vehicle mode 324, vehicle interface 326, user interface 328, speech 330, event 338, resource 340, preferences 344, and carlets 356. Additionally, a provisioning manager 334 is provided in the set 320. The addition filters and protocol services 318 can be labeled or termed filter or protocol provisioning and is supported in the architecture 300 through a collaboration between an off-platform provisioning system (such as provisioning agent 118 of FIG. 1) and the on-board provisioning manager 334. There are a number of reasons for provisioning a new filter or protocol service 318, removing an old service 318, or updating an existing service 318 depending on the operational context in which the architecture 300 is implemented. When the new filter or protocol service 318 is provisioned, it is added to the available services 318 and made available by the communications manager 350 for hot-plug in or dynamic update within a channel of one or more of the services in the set 320 without any downtime or with only minimal disruption.

FIG. 4 illustrates an exemplary process 400 performed by an extensible communications system (such as system 100) according to the invention to provision filters and protocol elements and to build and reconfigure communications channels for services. The process 400 includes providing a communications manager configured according to the present invention within a pervasive computing system (such as an in-vehicle network, within a mobile wireless device, or as part of a non-mobile wired or wireless computing network). The communications manager is configured to control creation of communications channels for services within the computing system and to manage the reconfiguration of existing channels to facilitate updating or otherwise changing communications channels on the fly. The communications manager at 420 discovers the available filters and/or protocol elements (such as by querying a registry at a linked service provider) and then stores the discovered filters and protocol elements on the device or structure hosting the computing system (or, at least, stores links to such filters and protocols that may be stored elsewhere).

At 430, a set of service components are installed (such as the set 320 of FIG. 3), which may follow a relatively standard installation of a component within a standardized framework (such as within an OSGi container). At 440, the communications manager, such as with a channel factory, builds communication channels for each service component by combining a protocol element with one or more filters. Alternatively, the channel may be built upon instantiation of the particular service to insure that any updates to the protocol elements and/or filters are included within the communications channel. The service then uses the channel for controlling communications within or outside the computing system. At 450, new protocol plug-ins and/or add-on filters are received and, at 460, the sets of available protocol elements and/or filters are updated by loading or storing the received items as available to the services (and this may include removing outdated filters or protocol elements from the set of available filters and protocol elements). At 470, the communications manager acts to dynamically reconfigure existing communications channels as needed for the running service components.

It may be useful to provide yet further explanation of the processes provided by the communications managers and other components of an extensible computing system of the present invention. FIG. 5 illustrates an exemplary class diagram for an object-oriented embodiment (such as may be used for implementing system 100) of a useful communications framework or service 500 showing important classes, which will be used to further discuss the methods of providing dynamic reconfiguration and provisioning of communications channels. A communications service may be designed as an OSGi service (as discussed with reference to FIG. 3) and receive incoming communication requests (such as from a service provider or from another service). The communications service creates appropriate InChannel objects and assigns them to the appropriate service. The communications service may also produce and offer OutChannel objects for the services to allow the services to communicate with external resources or systems (or, in some cases, with other on-board services).

The InChannel and OutChannel objects are combinations of one or more Filter objects and one and only one protocol Channel object. The Filter object may be a specialization of a decorator design pattern used in object-oriented programming or design where the output of one object in the pattern is chained to the input of another object (e.g., is useful for attaching responsibilities to objects at runtime or snapping functionality onto an existing object). The protocol Channel object understands send/receive requests from low-level network protocol stacks such as UDP, HTTP, Bluetooth, TCP/IP, and the like. The Filter object in contrast understands the upper layer or application level protocols such as those used for security, compression, transactions, specialized encoding, and the like (e.g., encryption algorithms, XML-oriented protocols, compression techniques. FilterChannel objects (such as the InChannel and OutChannel objects) realize a decorator pattern for addition of the data protocols or communications parameters dynamically and transparently to underlying channel or network protocol.

New communication channels are created for services as specializations of the Channel base class of FIG. 5. Creation of the communications channels is a preparatory step in utilizing a service component. Service components requiring communication with an external system (or, in some cases, with another on-board or in-vehicle service component) can obtain an OutChannel object by requesting the ChannelFactory with a resource identifier or by providing references to a network protocol and one or more filters. A resource identifier is a reference to a pre-existing channel object (such as a previously built OutChannel). The following Java code example shows one method of creating an OutChannel with HTTP as the network protocol and with an XML application filter:

HashMap properties=new HashMap( );

HashMap filters=new HashMap( );

properties.put(PROTOCOL,“Http”);

properties.put(“HTTP_URL”,“http://test.com/test”);

filters.put(“XmlOutChannel“, ””);

filters.put(“CompressionOutChannel“, ””);

properties.put(“FILTERS”,filters);

OutChannel out=ChannelFactory.getChannel(properties);

In this fashion, any set of filters can be concatenated to add and remove communication parameters such as encryption, compression, XML object bindings, and the like. New protocols and channels are created as separate specializations of the respective base classes or descendent communications classes and can be added because they satisfy polymorphic relationships in the patterns.

Preferably, the communications manager is able to dynamically update the channel with the necessary filters such as with appropriate or updated algorithms. Updating of filters is accomplished in one embodiment by utilizing the strategy design pattern of object-oriented design. This technique of updating allows manipulation of the filter (e.g., an algorithm) used to match resource constraints. The strategy design pattern is also exploited for dynamically adding the new data filters to boost the communication performance by adding the compression for significantly large amounts of data.

The communications manager, the provisioning manager and service discovery services of the inventive architecture collectively make it possible to dynamically update the filters. Filters are structured so that they have an independent existence from each other. In one embodiment (such as the one shown in FIG. 3), each filter is implemented as an OSGi service bundle in order to have the capability to independently add, remove, and manage the filters. Updating or providing a new filter can be termed filter provisioning and is supported through collaboration between an off platform provisioning system and an on-board provisioning agent service. When the new filter is provisioned, the communications manager adds this filter to its available set of filters so that existing services can hot-plug or dynamically update their channels without any downtime or with minimal downtime. If the filter is updated or removed, the communications service changes the mechanism or removes it while preserving operational capability. The provisioning operation can be managed along transactional boundaries so that unsuccessful attempts have their effects removed from the system, which limits the partial failure condition.

As a further example, when a new service is ready for production, it will publish itself as available in the service discovery of a computing system. The information provided with the service may include the network protocols and filters that the service can support. Consumers interested in the service send request through the portal's provisioning manager. The provisioning manager sends the service, its dependent services, communication filters and the dependencies to the provisioning service. Once this information has reached the provisioning service, the provisioning service can provision and start the service. At that point, the service with the most recently made available protocol element and filters in its communication channel is available to the computing system.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

We claim:

1. A system in a client device for providing communications channel on the client device, comprising:
a plurality of service components comprising applications providing a functionality on the client device, the service components utilizing a communications channel for communicating data related to the functionality;
a data storage element storing a set of available communications filters, the filters defining upper layer protocols for communicating digital data; and
a communications manager adapted for building the communications channels for the service components by combining at least one of the filters with a protocol element defining a network protocol.

2. The system of claim 1, wherein the communications manager selects the filters for the communications channels based on each of the service components, whereby each of the communications channels is matched to a corresponding one of service components.

3. The system of claim 1, wherein the communications manager performs the building of the communications channels when the service components are instantiated.

4. The system of claim 1, wherein the data storage element further stores a set of available protocol elements, the protocol elements defining differing network protocols and wherein the communications manager performs the building of the communications channel by first selecting a single one of the protocol elements to combine with the at least one of the filters.

5. The system of claim 1, wherein the set of filters includes filters for defining the upper layer protocols for at least encryption, compression, and XML-based data transfers.

6. The system of claim 2, wherein the interface application is a human machine interface application configured for use with the user interface descriptor.

7. The system of claim 1, further including a provisioning manager for receiving additional ones of the communications filters and making the additional filters available to the communications manager for use in the building of the communication channels and wherein the communications manager reconfigures at least one of the built communications channels based on the additional filters by repeating the building to create a reconfigured communication channel.

8. The system of claim 1, wherein each of the communication channels includes an in channel for inputting data to each of the service components and an out channel for outputting data from each of the service components, the in channel differing from the out channel for at least one of the service components.

9. A computer-based method for providing a communications channel for use by a service in a pervasive computing system, comprising:
providing a channel protocol element configured for a network communications protocol;
providing a set of channel filters each configured for an application-level communications protocol;
receiving a communications request for a service in the pervasive computing system;
based on the service, selecting one or more of the channel filters from the set;
combining the selected one or more filters with the channel protocol element to create a communications channel; and
making the communications channel available to the service.

10. The method of claim 9, wherein the providing of the channel filters includes implementing each of the channel filters as a service bundle within a client architecture of the pervasive computing system.

11. The method of claim 10, wherein the client architecture is an Open Services Gateway Initiative (OSGi) based architecture and the channel filters are implemented as OSGi service bundles.

12. The method of claim 9, wherein the created communication channel includes a first channel adapted for processing data input to the service and a second channel adapted for transferring data from the service.

13. The method of claim 12, wherein the selected one or more filters in the first channel differ from the selected one or more filters in the second channel.

14. The method of claim 9, further including after the providing of a set of channel filters, provisioning another one of the channel filters and after the communication channel making repeating the communication request receiving, the channel filters selecting, the combining, and the making, whereby the communication channel is dynamically reconfigured.

15. An on-board computing system, comprising:
means for making a plurality of communications filters available, the communications filters each adapted for understanding an upper level communications protocol;
means for providing a plurality of services within the in-vehicle computing system, each of the services providing a defined functionality; and
means for building a communications channel providing a pathway through which data is transmitted for one of the provided services, wherein the building means includes means for selecting one of the communications filters based on the one service and means for combining the selected filter with a channel protocol element adapted for understanding a lower level communications protocol to form a communications channel for use by the service.

16. The system of claim 15, wherein the communications channel includes an inlet communications channel for understanding data input to the service and an outlet communications channel for formatting data transferred from the service.

17. The system of claim 15, wherein the making means includes means for altering the available communications filters to include new filters and wherein the building means builds the communications channel using the altered available communications filters.

18. The system of claim 15, wherein the building means comprises a communications manager implemented as a client manager in a telematics client and the communications filters are implemented as service bundles in the telematics client.

19. The system of claim 18, wherein the telematics client is formed as an OSGi-compliant architecture.

20. The system of claim 19, wherein telematics client is further formed in connected limited device configuration (CLDC) or connected device configuration (CDC).
